(19) United States
(12) Patent Application Publication
(10) Pub. No.: US 2009/0296990 A1
(43) Pub. Date: Dec. 3, 2009

(54) EVALUATING DRIVER WALK DISTANCES AND BUILDING TYPES USING OVERHEAD IMAGERY

(75) Inventors: Charles L. Holland, Atlanta, GA (US); Jack D. Levis, York, PA (US); Stanley A. Engel, Cumming, GA (US); Vincent Paul Fiorayante, Baldwin, MD (US); Steven L. Smith, Powder Springs, GA (US); Kelli M. Franklin-Joyner, Alpharetta, GA (US); Jeffrey L. Winters, Perry Hall, MD (US); John A. Olsen, III, Cumming, GA (US); Mark Davidson, Alpharetta, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: United Parcel Service of America, Inc.

(21) Appl. No.: 12/256,962

(22) Filed: Oct. 23, 2008

Related U.S. Application Data
(60) Provisional application No. 61/057,520, filed on May 30, 2008.

(51) Int. Cl. G06K 9/00

(52) U.S. Cl. 382/106

(57) ABSTRACT

A method of determining a distance to be walked by a delivery vehicle driver including providing a satellite image that has an image of a building to which an item is to be delivered and an image of a street adjacent to the building. The method further includes defining a path, within the image, that corresponds to a path that the delivery vehicle driver will walk when delivering the item to the building. The method also includes the step of determining a length of the path.

### CROSS REFERENCE TO RELATED APPLICATIONS

This application claims the benefit of U.S. Provisional Application No. 61/057,520, filed May 30, 2008, which is incorporated by reference herein in its entirety.

### BACKGROUND OF THE INVENTION

Generally, work measurement is a technique for determining the amount of time required for a typical, qualified worker to complete a particular task at a normal pace. An industrial engineer or similar individual with expert knowledge of a process or method for performing a task is typically responsible for work measurement.

Work measurement studies of package delivery operations often require an engineer with expert knowledge of the package delivery job and methods. The expert typically performs a full day study of a package delivery driver by accompanying the driver on the driver's route. The work measurement study generally includes a record of actions actually performed by the driver and actions the driver should have performed. Based upon the activity of the driver as witnessed by the expert, the expert may be able to determine how the driver can be more efficient in delivering packages.

Unfortunately, it is an expensive, time consuming process to train engineers to become experts in package delivery driver methods and procedures for work measurement purposes. To perform a traditional work measurement study, the observer must be an expert in driver methods in order to know what actions to allow or disallow. Developing the ability to make these decisions in real-time, as the driver does his or her job, takes considerable practice and knowledge. It would be advantageous to be able to perform work measurement studies of package delivery drivers without expensive training costs and to be able to complete each study in less than a full day.

### SUMMARY OF VARIOUS EMBODIMENTS OF THE INVENTION

Generally speaking, a work measurement method according to various embodiments of the invention includes using aerial and/or satellite imagery to determine driver walk distances (e.g., from a driver's delivery vehicle to a drop-off location adjacent a building (e.g., a house or office building)) and/or to classify the type of building to which an item is to be delivered. For example, in particular embodiments, a work measurement analyst using aerial and/or satellite imagery can estimate a target time duration for a delivery route based at least partially upon walk distances for drivers and/or building classification types.

A method of determining a distance to be walked by a delivery vehicle driver according to particular embodiments of the invention comprises the steps of: (A) providing a satellite or aerial image that comprises: (1) an image of a building to which an item is to be delivered, and (2) an image of a street adjacent the building; (B) defining a path, within the image, that corresponds to a path that the delivery vehicle driver will walk when delivering the item to the building; and (C) determining a length of the path.

In addition, a method of assessing a classification of a building according to various embodiments of the invention comprises the steps of: (A) providing an aerial or satellite image that comprises an image of the building; and (B) assessing a classification of the building from the aerial or satellite image.

Furthermore, a method of assessing an estimated amount of time that it should take to deliver an item to a recipient within a particular building comprises the steps of: (A) providing an aerial or satellite image that comprises an image of the building; (B) based on the aerial or satellite image, determining a particular building classification associated with the building; and (C) obtaining a standard delivery time value that corresponds to the particular building classification.

### BRIEF DESCRIPTION OF THE DRAWINGS

Having thus described the invention in general terms, reference will now be made to the accompanying drawings, which are not necessarily drawn to scale, and wherein:

FIG. 1 is a screen shot showing a walk measurement line on a virtual globe image according to a particular embodiment of the invention.

FIG. 2 is a flow diagram of a method of determining a distance to be walked by a delivery vehicle driver.

FIG. 3 is a flow diagram of a method of assessing a classification of a building.

FIG. 4 is a screen shot of a building in a virtual globe image according to a particular embodiment of the invention.

FIG. 5 is a flow diagram of a method of assessing an estimated amount of time that it should take to deliver an item to a recipient.

FIG. 6 is a work measurement report sheet according to one embodiment of the invention.

### DETAILED DESCRIPTION OF VARIOUS EMBODIMENTS OF THE INVENTION

The present invention will now be described more fully hereinafter with reference to the accompanying drawings, in which various embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

Exemplary Package Driver Job Description

The job of a delivery driver includes delivering and picking up packages. As such, a delivery driver typically needs to be certified to drive commercial delivery vehicles. In addition to a delivery vehicle, the delivery driver may utilize a hand-held computer, such as a Delivery Information Acquisition Device (DIAD), which may collect data regarding deliveries and pickups, and other aspects of the driver's day.

Types of Package Delivery Stops

A package delivery driver generally encounters three types of stops. A first type of stop involves delivering a package to a residential address, where the package can typically be dropped off safe from the sight of passersby and safe from weather. For example, the delivery driver may place a package on the floor of a porch area of a residence that is at least partially covered. Since the package in this situation is released without a signature, this kind of stop is commonly called a driver release stop. In a driver release stop, the driver's walk between his or her delivery vehicle and the residence is typically the most time-consuming part of the stop. Thus, efficient walking routes are valuable in the delivery industry and are typically analyzed for accounting, planning, and employee performance evaluation purposes. One element used in estimating walking times is a person's walking speed. For analytical purposes, the delivery industry has set standard walking speeds for delivery drivers. Therefore, since the walking speed is considered to be a constant in the delivery industry, the estimated time to complete the walking portion of a driver release stop is simply a function of the distance between the driver's vehicle and the package drop-off point at the residence (e.g., the length of a path between the exit point of the driver's delivery vehicle and a drop-off point adjacent the residence). In addition to the time estimated for the walking portion, various allowances may be included to complete the time estimation of an entire driver release stop, such as a package type allowance (e.g., an allowance of additional time for handling particularly large packages) and a door type allowance. Further allowances may be provided for different types of terrain and for multi-unit structures such as apartment and condominium buildings. For example, a terrain with an inclined walkway or a walkway with steps may require additional walking time compared with a relatively flat walkway covering the same distance. Although some multi-unit structures may provide a central location for delivery stops, which results in relatively uniform delivery stop times, walking time for delivery stops at multi-unit structures without a central delivery stop location may vary widely depending on the unit. For example, delivery stops at some units may require delivery drivers to walk around other units, to walk up or down stairs, or possibly use elevators. Additionally, a single delivery stop may involve multiple items that may require repeat trips along a walking path. Accordingly, a variety of allowances may be included to account for the geographical, structural, and/or logistical features of a particular delivery stop.

A second type of stop involves delivering a package to a business or a residential address where a signature is required or where it would be unsafe to leave the package unattended for later retrieval by the customer. This type of stop is commonly called a signature stop. Packages may require a signature by the intended recipient of the package based on, for example, the type of entity receiving the package, such as certain business entities. Also, some packages may require a signature based on the item type, such as for expensive, potentially dangerous, and/or confidential items. Alternatively, a customer may request the requirement of a signature by the recipient of the package as a condition for the delivery driver to release the package. For a variety of reasons, particularly the safety of a package, a delivery driver may decide that circumstances prevent the delivery of a package. For example, weather conditions, including events such as a snow storm, and/or a general lack of cover to protect a package may prevent the delivery of a package when a customer is not present.

A third type of stop generally encountered by package delivery drivers is called a pickup stop. As the name suggests, a pickup stop involves the retrieval of packages for shipment by drivers. The estimated time for the completion of signature stops and pickup stops is generally a function of the type of building used by the customer. For example, if the customer's business is located in an office building, then the delivery driver may encounter a longer stop time as compared to the amount of time needed for a customer that has a receiving dock or the like. Thus, in various embodiments, each building classification type corresponds to an allowance or amount of time representing how long a delivery should take in such a building. As is the case with driver release stops, other allowances may be included for signature and pickup stops to estimate the entire time needed for a stop.

By determining the walking distances that the delivery driver will be required to walk, classifying the buildings to which the driver will need to deliver items, and making other allowances appropriate for the delivery stops, an estimate may be determined regarding the amount of time it should take the delivery driver to complete each individual stop on a delivery route. This information may be used in the process of estimating the total time that it should take for the driver to complete his or her entire delivery route.

Creating Driver Release Stops

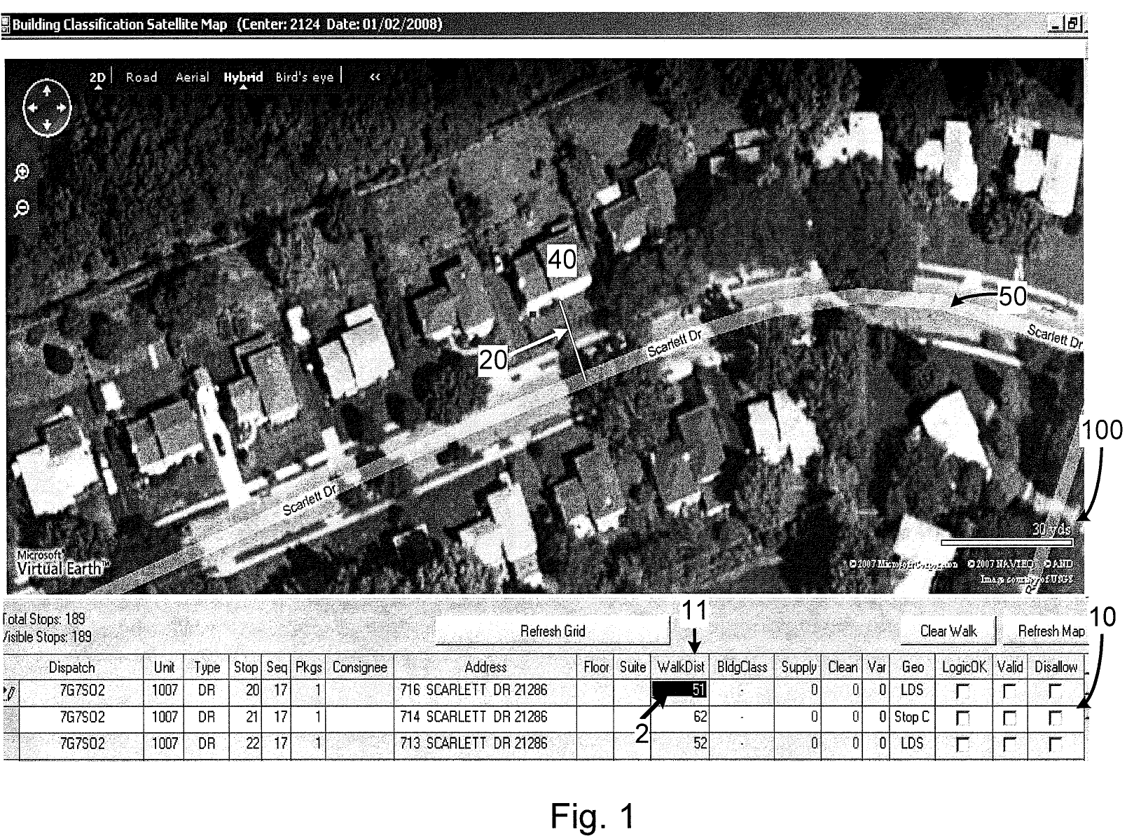

As can be seen in FIG. 1, current virtual globe programs and similar systems provide aerial and satellite images showing portions of the surface of the Earth, including trees, lakes, man-made structures, etc. Virtual globes may generally be described as software models of a planet or portions thereof which may include geographic features, roads, driveways, sidewalks, and/or buildings, among other features. These models may be three-dimensional and may be built from high-resolution satellite and/or aerial images. Virtual globe programs include, for example, Microsoft® Virtual Earth™, NASA World Wind, ArcGIS Explorer, Software MacKiev's 3D Weather Globe™ & Atlas, Norkart Virtual Globe, and Google™ Earth. These programs may have many interactive features, including information filtering and powerful search capabilities.

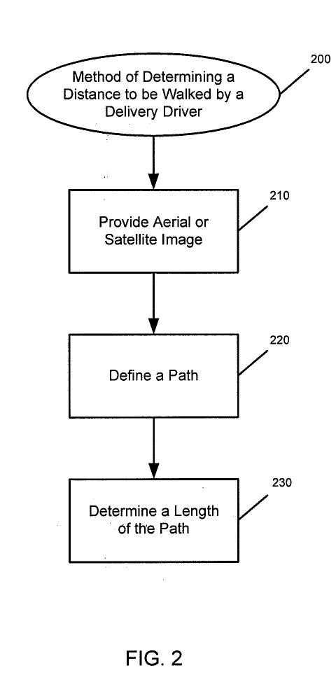

FIG. 2 shows an exemplary method 200 of determining a distance to be walked by a delivery driver. In particular, as shown in FIG. 2, a satellite image or aerial image may be provided in Step 210. In various embodiments of the invention, a user may request to view a particular geographic area through a user interface of a virtual globe program or similar system. Next, in Step 220, a walking path may be defined on the satellite or aerial image. For example, a user may draw a line on a geographic area image, such as a line between a building or residential house and a street, using the user interface of the virtual globe program or similar system. Alternatively, the user may enter map coordinates into the virtual globe program or similar system to generate the line. It should be understood in light of this disclosure that other ways of creating a line with the virtual globe program may be used. For example, a delivery worker may save coordinates of a residence, street, or the like using a GPS receiver or similar device as the worker travels along the worker's route. By downloading and processing these coordinates, lines may be drawn on a geographic area image between, for instance, a street location and a residence location. These lines may be straight lines and/or may be curved, and may be shaped to reflect the path that a delivery driver would travel from the driver's vehicle to an item drop-off point (e.g., a package drop-off point) near the building.

As shown in FIG. 1, an aerial or satellite image 100 is shown with a straight line 20 extending between a house 40 and a road 50, e.g., Scarlett Drive. In FIG. 1, line 20 represents the walking path that the package delivery driver may typically take to the household 40 after parking the delivery vehicle on the road 50. As shown in FIG. 2, the virtual globe program according to various embodiments is capable of determining the length of lines drawn or entered on the image, shown as Step 230. For example, FIG. 1 shows the length 2 of line 20 in the spreadsheet 10 under the column 11 titled “WalkDist.” The length of the lines drawn or entered on the image may be determined using a distance measurement tool associated with the virtual globe program. Accordingly, walking paths for various delivery stops may be entered into virtual globe programs and the like, and the lengths of the paths may be determined.

Classifying Signature and Pickup Stops

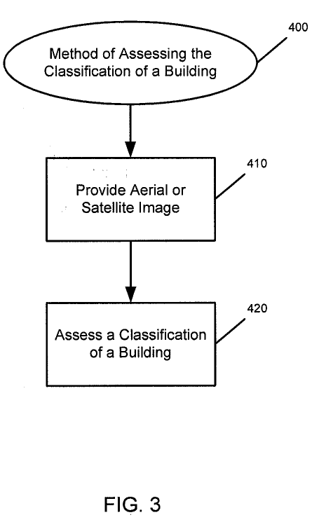

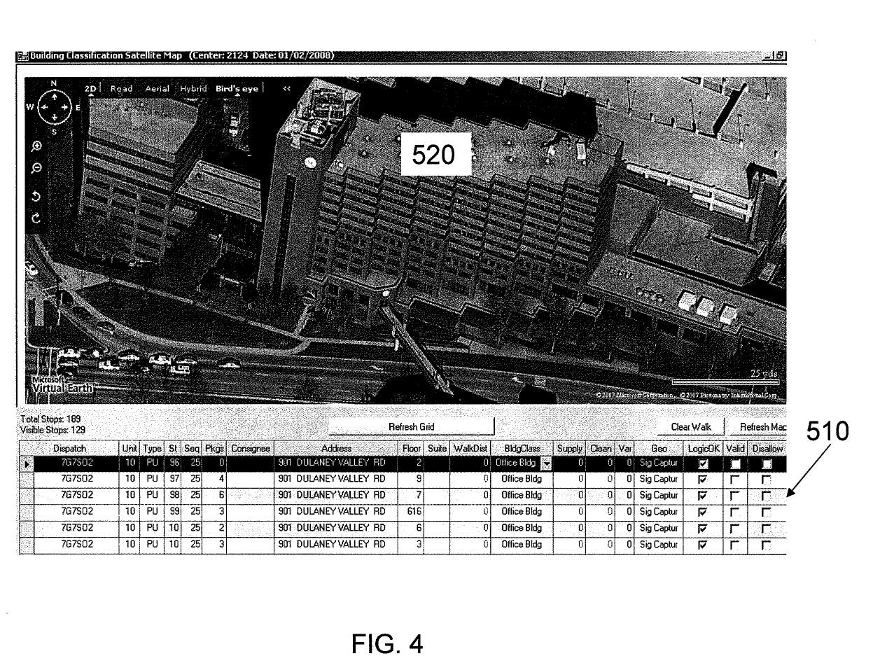

Through a user interface of a virtual globe program or similar system, a user may classify buildings or structures in various ways. FIG. 3 shows a method 400 of assessing the classification of a building. The method 400 includes providing aerial or satellite images 410 and assessing a classification of a building 420. One way of classifying a building or structure is by manually entering the classification, which may include an allowance, into the user interface of a virtual globe program or similar system. The classification may be entered into the virtual globe program or similar system using methods such as by typing in a classification name, selecting a classification from a pull-down menu, or the like. For example, as shown in FIG. 4, a building 520 is classified in the drop-down spreadsheet 510 under the column titled “BldgClass.” FIG. 4 shows the building 520 classified as an Office Building.

Another way of classifying a building or structure is by using a database (e.g., a commercial database) that includes building information—such as the GPS coordinates of buildings and their respective classification types. Using this technique, a user (or software program) may, for example, retrieve the classification of a building from the database based on the building's GPS coordinates. In one embodiment, the database may be populated by geocoding performed by delivery workers. Geocoding is a process which associates a specific geographic location, such as GPS coordinates, with a street address or other identifier. Delivery workers may geocode certain delivery stop locations in real-time at a delivery or pickup location using a DIAD or other computer device.

In any case, the buildings and structures along the delivery route requiring signature and pickup stops may be classified using a virtual globe program or the like, which provides useful information for work measurement analysis.

Work Measurement Processing Program

In various embodiments, a work measurement processing program executed by a processor of a computing device retrieves, or simply receives, the walking distance and classification information disclosed above. In addition, the work measurement processing program processes this data and other forms of allowances, such as package type and driving time, to determine how long it should take delivery personnel to complete individual stops, entire delivery routes, or the like. Furthermore, the work management processing program may be configured to process the walking distance and classification data only when selected by a user or automatically, such as periodically, continuously, or the like. According to various embodiments, the work management processing program may be any type of computer code or software program that may interface with virtual globe programs or the like, and the work management processing program may be stored on a computer readable medium and executed by a computer processor.

Using the length of a walking line, e.g., walking distance, the work management processing program estimates how long it should take a delivery driver to walk up to a residence and walk back to the delivery vehicle. In particular, an estimation of the time needed for a driver release walk may be computed by multiplying the industry standard for the time it takes an average person to walk a given distance (e.g., sometimes represented in minutes per foot) by the calculated walking distance from the delivery vehicle to the residence and then back to the delivery vehicle.

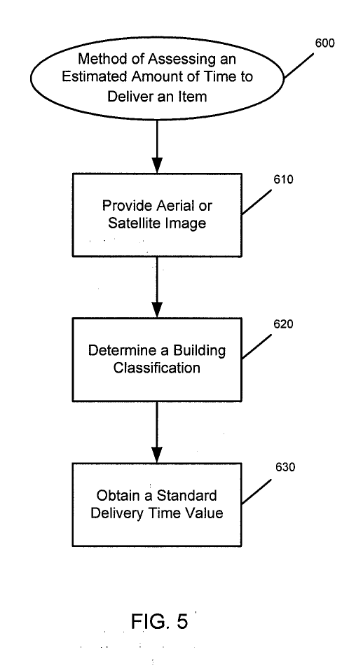

Using a building's classification, the work management processing program may estimate the time it should take for the delivery driver to perform a signature or pickup stop. For example, FIG. 5 illustrates one embodiment of a method 600 performed by the work management processing program to assess an estimated time that it should take to deliver an item. The method 600 begins at Step 610 by providing aerial or satellite images. Next, in Step 620, the method determines a building classification, and in Step 630, a standard delivery time value is obtained. In particular, each building type may be assigned a standard allowance, which is an estimation of the amount of time needed for a worker to deliver a package or pickup a package within the specified type of building. A standard allowance or standard delivery time value for a building may be determined by accessing a database containing standard delivery time values. A building's classification, a delivery driver's walking distance, driving time, and other allowances are generally used in calculating the time required for delivery stops and/or delivery routes. As discussed further below, a recorded actual delivery time may be compared against the total standard delivery time value for a particular building. Based upon this comparison, a delivery worker's efficiency may be computed.

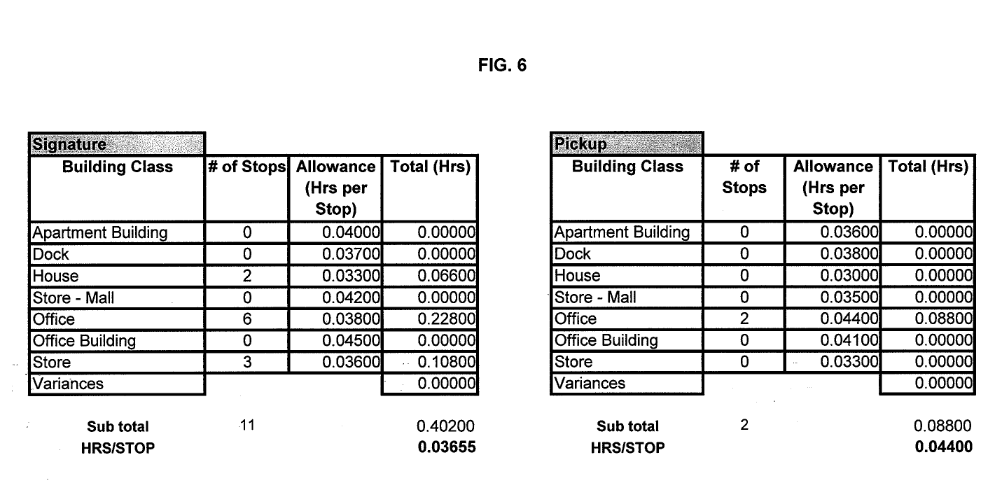

FIG. 6 includes two tables. The table on the left depicts, for all signature stops on a particular delivery route: (1) the number of stops of each building class type on the delivery route; (2) a time allowance for each building type (e.g., a target amount of time that it should take a delivery person to deliver an item to that particular class of building); and (3) the total allowance of time that the delivery driver should typically take to complete signature stops of each building class on the route. A calculation of the driver's total allowances for signature stops for the route is provided below this table, along with the average allowance per signature stop. The table on the right in FIG. 6 depicts similar information for pickup stops on this particular route. Although not shown in FIG. 6, the time estimation calculation for driver release stops may also be displayed in a similar tabular format.

According to various embodiments, the work management processing program may also be configured to compare the amount of time it actually takes a worker to make deliveries, including individual delivery stops and/or the entire delivery route, with the estimated time calculated using walking distances, building classification types, and other allowances, such as driving time. For example, a comparison of a delivery worker's actual performance with the estimated performance may be made at the end of each working shift. Of course, a comparison may be made at other times and/or may include multiple days of work. The actual duration of time may be recorded through the use of various types of devices, such as time stamps, wrist watches, wall clocks, computers (e.g., a DIAD device running computer software), or the like. The results of the comparison may provide a worker with an assessment of his or her efficiency or feedback regarding whether or not the worker met delivery time goals, e.g., estimated times. Alternatively or in addition, the results of the comparison may provide dispatch planners with a more practical understanding of the time required for various delivery stops.

In the case of a driver release stop, the work management processing program may compare a worker's actual delivery time with the estimated time by simply juxtaposing the duration of the driver release stop with the calculated estimate. The estimated time for the driver release stop may be calculated by determining the time required for a worker to walk the path to and from the item drop-off point. In one embodiment, a virtual globe program may be used to determine the distance from the worker's starting position on the street to the item drop-off point, and then calculate the estimated time to walk that distance and then back to the starting position by applying the delivery industry constant for walking speed. However, the assumptions of a standard package size and a delivery industry standard walking time or rate are sometimes inadequate for accurately estimating delivery times. Thus, in some cases, calculating a worker's walking time based exclusively on walking distance may provide an inaccurate estimate of the time required for the driver release stop because this calculation ignores factors such as stairs and gates, which may increase the delivery time. Accordingly, the total time estimate may also include allowances to account for the variety of building classifications, terrain features, and/or other factors necessary to provide an accurate time estimate for the driver release stop.

As with driver release stops, accurate time estimates for signature stops and pickup stops may require additional allowances. A meaningful comparison of a worker's actual delivery time for a signature stop with the estimated delivery time may require allowances to account for the time during which the worker must locate the signing customer and wait for the customer to provide a signature, among other factors. Similarly, time estimates for pickup stops may include allowances for such factors as receiving multiple items of differing weights and sizes. Time estimates may be compared with actual delivery times to evaluate, for instance, worker performance.

In one particular embodiment, actual delivery times and locations may be recorded using a suitable portable electronic device (e.g., a DIAD that includes a GPS receiver, radio and a portable computing system). In various embodiments, the estimated time, which may be downloaded, saved to the portable electronic device, or the like, may be compared in real-time (or substantially in real-time) with the actual movements of a worker. Optionally, the real-time comparison may be displayed to the user (e.g., via the portable electronic device) substantially in real-time. This real-time comparison may benefit the worker by immediately directing him or her to more efficient delivery practices. For example, the work management processing program may calculate the latest time that a user could leave a delivery stop and still arrive at the next delivery stop before exceeding the delivery or pickup deadline. Furthermore, the work management processing program and/or a dispatcher may notify the user, such as by sending a message to the user's DIAD or otherwise, of the time by which the user must leave to meet their next deadline. The real-time comparison may also benefit delivery dispatchers or the like by providing them with the present status of each delivery vehicle or worker, such as the current location of a delivery vehicle or worker, and by providing projections of where delivery vehicles will be and when the delivery vehicles will be there.

According to various embodiments, time estimates may also be determined by combining automated image processing and analysis techniques for satellite and/or aerial images with manual processing and analysis techniques. Because of low image quality or ambiguous image features, some satellite and/or aerial images may be inadequate for calculating time estimates. In one embodiment, a database may store locations (e.g., addresses or GPS coordinates) where automated image processing and analysis is inadequate and store information (e.g., time estimates) for drop-offs and pickups at these ambiguous or complicated delivery stop locations. Additionally, in another embodiment, allowances may be provided to account for the additional time required for delivery stops with ambiguous drop-off or pickup locations. In other embodiments, a delivery driver may identify such locations in real-time using a DIAD or other handheld computing device having GPS capability, and/or a driver may be notified of information relating to such locations via a DIAD or other handheld computing device in communication with a hub facility.

Actual time for completing a delivery stop and location data may be stored in a GPS device, DIAD, or other computing device, or this data may be transmitted to another device to be stored and/or processed according to various embodiments. As disclosed above, the information may be transmitted to delivery dispatchers for analysis, for example. Delivery dispatchers and/or delivery supervisors may compare a delivery worker's actual time for completing a delivery stop or delivery route with the estimated time for that stop or route. Also, dispatchers and supervisors may compare the actual times of different workers for a particular delivery stop or delivery route or compare the actual times of the same worker, on different occasions, for a particular delivery stop or delivery route.

A delivery worker's historical patterns or decisions may be analyzed both for performance evaluations and for planning future schedules. For example, a comparison study may show that some workers perform better on a particular delivery stop or delivery route. This type of information may be used to increase the efficiency of a delivery stop or delivery route by assigning workers to routes where they perform well. This is just one example in which a system may be configured to compare the time it actually takes a worker to complete a delivery stop or delivery route with information such as the estimated time to complete that delivery stop or delivery route. According to various embodiments, the dispatchers and supervisors may also incorporate or consider other factors, such as weather conditions, time of the day, time of the year, and/or day of the week, for estimating times for delivery stops and routes and evaluating the efficiency of the delivery worker.

The delivery industry generally values efficiency in performing its deliveries and pickups, as well as accuracy and precision in scheduling and predicting delivery and pickup times. However, the techniques in this disclosure are not limited to business or industrial applications. Rather, these methods and principles may also be relevant to consumer and government applications. One example of a government application is school bus routes and stops. Using the methods disclosed here, school administrators may determine the distance and time students must walk from their homes to their bus stop, as well as the distance and time from their bus stops to their homes. Allowances, such as accounting for elevation changes, may be considered in the passenger transportation application because the shortest walking distance may not provide the shortest walking time. In some situations, more time may be allotted for passengers walking up a hill than for walking down that same hill. Thus, these methods may be used for determining where to place a bus route, where to place bus stops along a route, what passengers to assign to a bus stop for picking up those passengers, and/or what passengers to assign to a bus stop for dropping off those passengers. In addition to school bus systems, these methods and principles may also be applied to other forms of transportation, such as passenger railway systems or municipal bus systems.

Another example of a government application that utilizes the methods disclosed above includes the management of emergency responder services. In particular, using the above methods to provide more accurate driving and walking directions provided to emergency responders, such as police and fire services, allows the emergency responders to reach people in houses and other structures more quickly. For example, high-resolution satellite and/or aerial images may contain recognizable features such as sidewalks, driveways, and fire hydrants so that firefighters may determine where to enter different structures, how long of a walk they will have, and where the nearest fire hydrant is located. In addition, the above described methods may be used for planning purposes to determine where to place fire hydrants. Furthermore, a database of building classifications, including details such as which floors of a multi-use building are residential, may be used by emergency responders to increase their efficiency and reduce their exposure to potentially hazardous environments.

Another industry that may utilize the methods disclosed herein is product distributors that distribute products to retail stores. For instance, a soft drink company may increase the efficiency of its soft drink distributions to restaurants, convenience stores, and other entities by calculating the walking distances and walking times to these entities for their delivery employees. The soft drink company may also provide allowances for different weights and quantities of their products and may consider these allowances with the walking time estimates to schedule more efficient deliveries. As is the case with any heavy product, the walking time required to transport the product to the drop-off point may be greater than the walking time required when walking back from the drop-off point without the product. Accordingly, accurate time estimates may require distinguishing between the walking time of a delivery worker with a product and the walking time of a delivery worker without a product.

It should be understood in light of this disclosure that the techniques described above may be implemented manually or using any suitable computer system. For example, in certain embodiments of the invention, appropriate software for executing the techniques discussed above may be run by a computer server that comprises one or more suitable computer processors and memory. In particular embodiments, users may access this server and run the appropriate software via a suitable network, such as the Internet.

Many modifications and other embodiments of the invention will come to mind to one skilled in the art to which this invention pertains having the benefit of the teachings presented in the foregoing descriptions and the associated drawings. For example, as will be understood by one skilled in the relevant field in light of this disclosure, the invention may take form in a variety of different operational configurations. Therefore, it is to be understood that the invention is not to be limited to the specific embodiments disclosed and that modifications and other embodiments are intended to be included within the scope of the appended exemplary concepts. Although specific terms are employed herein, they are used in a generic and descriptive sense only and not for the purposes of limitation.

1. A method of determining a distance to be walked by a delivery vehicle driver, said method comprising the steps of:
providing a satellite image that comprises: (A) an image of a building to which an item is to be delivered; and (B) an image of a street adjacent said building;
defining a path, within said image, that corresponds to a path that said delivery vehicle driver will walk when delivering said item to said building; and
determining a length of said path.

2. The method of claim 1, wherein said step of determining said length of said path comprises using said satellite image to determine said length of said path.

3. The method of claim 1, wherein said building is a residential house.

4. The method of claim 1, wherein said item is a package.

5. The method of claim 1, wherein said satellite image is obtained from a virtual globe program.

6. The method of claim 1, wherein said step of defining said path comprises drawing said path on said satellite image.

7. The method of claim 1, wherein:
said satellite image is obtained from a virtual globe program; and
said step of determining said length of said path comprises using a distance measurement tool associated with said virtual globe program to determine said length of said path.

8. A method of determining a distance to be walked by a delivery vehicle driver, said method comprising the steps of:
providing an aerial image that comprises: (A) an image of a building to which an item is to be delivered; and (B) an image of a street adjacent said building;
defining a path, within said aerial image, that corresponds to a path that said delivery vehicle driver will walk when delivering said item to said building; and
determining a length of said path.

9. The method of claim 8, wherein said step of determining said length of said path comprises using said aerial image to determine said length of said path.

10. The method of claim 8, wherein said aerial image is obtained from a virtual globe program.

11. The method of claim 8, wherein said step of defining said path comprises drawing said path on said aerial image.

12. The method of claim 8, wherein:
said aerial image is obtained from a virtual globe program; and
said step of determining said length of said path comprises using a distance measurement tool associated with said virtual globe program to determine said length of said path.

13. A method of assessing a classification of a building, said method comprising:
providing an aerial or satellite image that comprises an image of said building; and
assessing a classification of said building from said aerial or satellite image.

14. The method of claim 13, wherein assessing a classification of said building comprises accessing a database containing classification data.

15. The method of claim 13, wherein assessing a classification of said building comprises determining an allowance for said building.

16. A method of assessing an estimated amount of time that it should take to deliver an item to a recipient within a particular building, said method comprising the steps of:
providing an aerial or satellite image that comprises an image of said building;
based on said aerial or satellite image, determining a particular building classification associated with said building; and
obtaining a standard delivery time value that corresponds to said particular building classification.

17. The method of claim 16, wherein said step of obtaining said standard delivery time value comprises accessing said standard delivery time value from a database.

18. The method of claim 16, further comprising recording at least one actual delivery time for the particular building.

19. The method of claim 18, further comprising comparing the at least one actual delivery time against the standard delivery time value for the particular building.

20. The method of claim 19, further comprising determining the efficiency of at least one delivery worker for at least one building.
